(19) United States
(12) Patent Application Publication
(10) Pub. No.: US 2011/0184854 A1
(43) Pub. Date: Jul. 28, 2011

(54) MERCHANT RATE LOOKUP

(76) Inventors: Philip D. Beck, Lido Beach, NY (US); Paul Whittle, Alpharetta, GA (US)

(21) Appl. No.: 12/811,614

(22) PCT Filed: Dec. 30, 2008
(86) PCT No.: PCT/US08/14147

§ 371 Date: Dec. 7, 2010

Related U.S. Application Data
(60) Provisional application No. 61/019,093, filed on Jan. 4, 2008.

(51) Int. Cl. G06Q 40/00; G06Q 30/00

(52) U.S. Cl. 705/39

(57) ABSTRACT

A system and method operate with a commerce processing system to determines a dynamic currency conversion markup rate for a given merchant and card number of a customer. The system and method determine the currency that is offered to the customer for the dynamic currency conversion transaction to support an opt-in process, so that an indication of a selected currency can be passed to a merchant in addition to the converted amount. Rate lookup logic is performed for every dynamic currency conversion transaction, and the data is arranged to be quickly accessed and occupies a minimum amount of memory storage space. Each merchant can elect to use a different rate for their customers based on business arrangements with the commerce processing system, their acquirer, the nature of their business, their competitors, and prevailing local market conditions.

### BACKGROUND OF THE INVENTION

1. Field of the Invention

This invention relates to financial transactions, and in particular to a system and method for determining a Markup Rate using Merchant Rate Lookup (MRL) for dynamic currency conversion (DCC) during a commercial transaction.

2. Description of the Related Art

In commercial transactions, customers may utilize known financial payment methods and devices known as credit cards, debit cards, and other known financial payment arrangements for conducting commercial transactions with merchants. Such financial payment methods and devices employ a primary account number (PAN), associated with a customer, which is transmitted from the customer to a merchant, banks, and other entities such as intermediary institutions, in order to complete a commercial transaction, such as a point-of-sale (POS) purchase or an online order.

Due to the global extent of commerce as well as different currencies utilized by different commercial and financial entities and countries, commercial transactions may require currency conversion for completion of the commercial transactions. In addition, customers as well as merchants may have preferences as to which currency to be utilized. Furthermore, during currency conversion, exchange rates and other markup values may affect the costs of the commercial transaction.

Dynamic currency conversion (DCC) is a known method for performing such currency-based commercial transactions. However, commercial systems in the prior art have not effectively determined markup rates in transactions between a given merchant and a customer.

Some prior art systems perform rate lookup in DCC transactions. However, the data upon which rate lookup relies is often slow to be accessed which delays completion of the transaction, and the rate lookup data may occupy large amounts of memory.

### BRIEF SUMMARY OF THE INVENTION

By employing the disclosed system and method, a commerce processing system determines the DCC Markup Rate for a given merchant and PAN of a customer. Additionally, the system and method are capable of determining the currency that is offered to the customer for the DCC transaction to support an opt-in process, so that an indication of a selected currency can be passed to a merchant in addition to the converted amount.

An integral component of DCC processing is to determine the mark-up rate that is used for the transactions. Typically the mark-up rate will consist of a base rate and some markup value based on different variables. The disclosed system and method are used to determine the mark-up rate.

Rate Lookup Logic is required to be performed for every DCC transaction, and it is important to arrange the data in such a manner that the data may be quickly accessed and which occupies a minimum amount of memory storage space.

Each merchant can elect to use a different rate for their customers based on business arrangements with the commerce processing system, their acquirer, the nature of their business, their competitors, and prevailing local market conditions.

### BRIEF DESCRIPTION OF THE SEVERAL VIEWS OF THE DRAWINGS

Preferred embodiments of the invention are disclosed hereinbelow with reference to the drawings.

FIG. 1 is a schematic of the system of the present invention.

FIG. 2 is a schematic showing the relationship between data tables in the present invention.

### DETAILED DESCRIPTION OF THE INVENTION

A system 10 and method of the present invention employ high-level logic, as described herein, for determining a markup rate using merchant rate lookup (MRL) for dynamic currency conversion (DCC) during a commercial transaction.

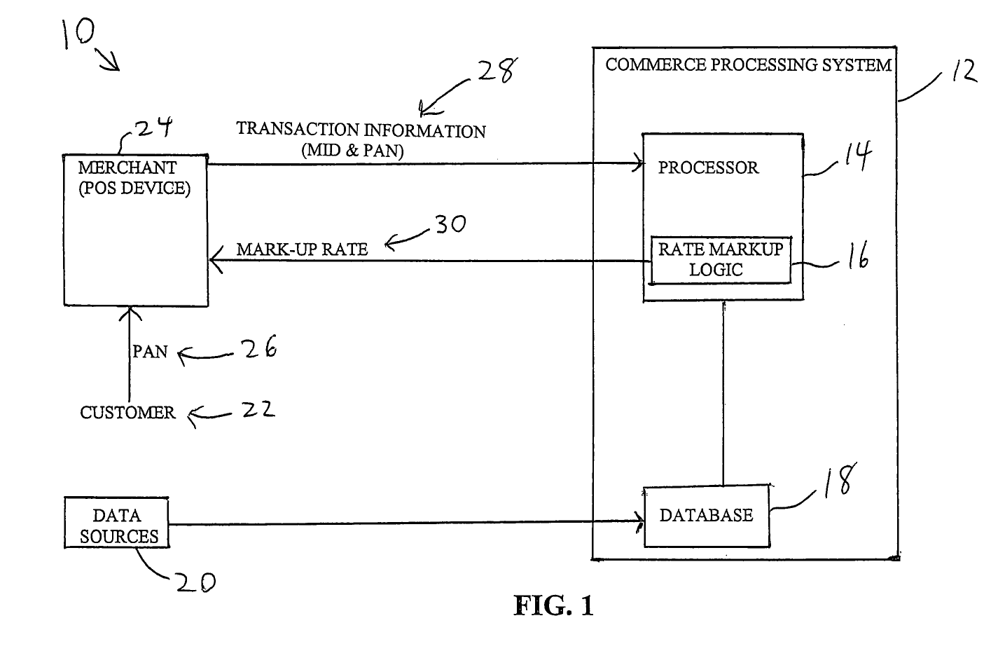

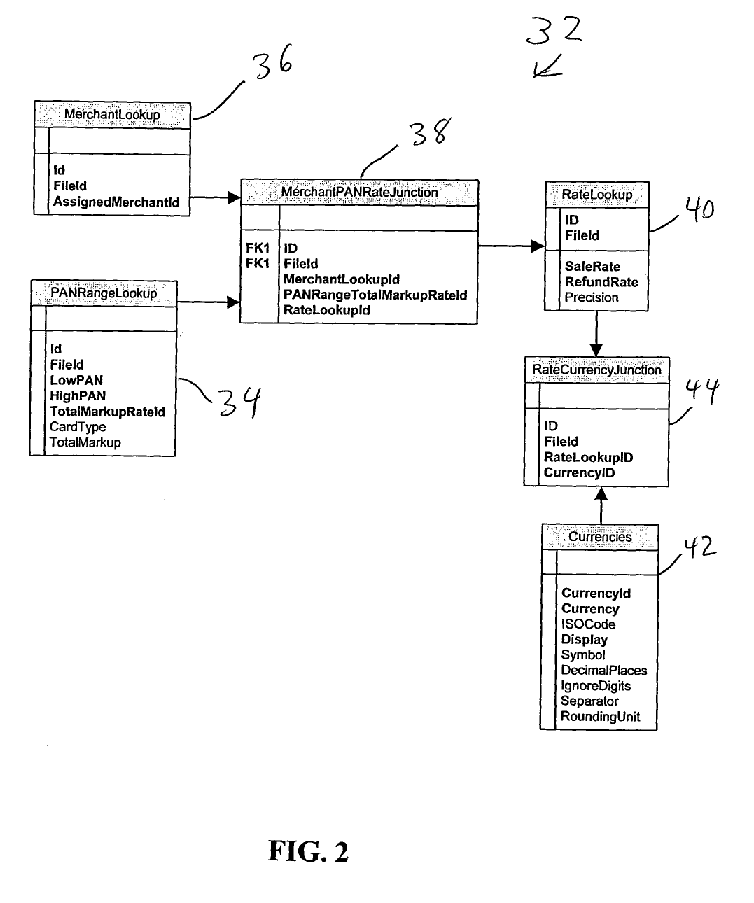

Referring to FIGS. 1-2, the system 10 includes a commerce processing system 12 having a computer-based processor 14 utilizing hardware and/or software for implementing rate markup logic 16, and a database 18 including memory and other storage devices for receiving and storing data from data sources 20, such as currency exchange and conversion rates.

The commerce processing system 12 may implement or be incorporated in a “PLANETSWITCH” system commercially available from “PLANET PAYMENT, INC.” The database 18 may be an SQL-based database and information storage and retrieval system.

When a customer 22 engages in a commercial transaction with a merchant 24 using, for example, a point-of-sale (POS) device, the customer 22 inputs or otherwise provides the merchant 24 with a PAN associated with the customer 22.

The merchant 24 then generates transaction information 28, which includes the PAN 26 of the customer as well as a merchant identification number (MID) associated with the merchant 24, and the merchant 24 transmits the transaction information 28 to the commerce processing system 12. Using the components and methods described herein, the commerce processing system 12 generates a mark-up rate 30 which is transmitted to the merchant 24 for completion of the transaction, for example, using dynamic currency conversion, and/or for providing the mark-up rate 30 to the customer 22.

The merchant 24 may have credit card processing capability, for example, using a point-of-sale (POS) device, or other known financial payment arrangements for conducting commercial transactions with customers.

The processor 14 may include or be connected to the database 18 providing tables and other credit card processing data populated by various data sources 20, such as rates and identification information of various credit card companies and associations.

The disclosed method of the present invention, using the system 10 in FIG. 1, enables the merchant rate lookup (MRL) capability for performing dynamic currency conversion, to provide a foreign currency conversion service such as “TIME-OF-SALE DYNAMIC CURRENCY CONVERSION” commercially available from “PLANET PAYMENT, INC.”. Such dynamic currency conversion is performed at the time of sale by dynamic currency conversion means, for example, as described in U.S. application Ser. No. 10/704,342, filed Nov. 7, 2003; which has been published as U.S. Patent Application Publication Number US 2004/0148255 A1, published on Jul. 29, 2004, which is incorporated herein by reference in its entirety.

Using dynamic currency conversion, any user using the system of the present invention may conduct commerce in which such users, including internationally located consumers, are provided the option to have transactions by payment cards, such as by credit card, debit card, or pre-paid card, converted in real time at the point of sale from the currency in which the merchant or vendor, and/or the other entities offers its goods into the currency in which the caller's credit card, debit card, or pre-paid card is billed while the merchant still conducts business in its local currency. The dynamic currency conversion performed by the dynamic currency conversion means provides pricing transparency and clarity at the POS, allowing customers to make more informed purchasing decisions at the time of purchase or of conducting the commerce.

The processor 14 may include hardware such as microprocessors and/or software embodied in at least one predetermined program for implementing the rate markup logic 16 and dynamic currency conversion. The at least one program may include “FX ASSURED”, a program commercially available from “PLANET PAYMENT INC.”, where the rate provided by the commerce processing system 12 is guaranteed to provide a final cardholder an amount that is lower than the amount the cardholder, as the customer 22, would pay for a transaction if the cardholder chose to not participate in the DCC process. The amount the cardholder would pay without DCC participation would include Foreign Exchange charges and exchange rate markups that are applied by a Card Association and the Card Issuer associated with the credit card or other known financial payment arrangements with the cardholder 22 utilizing the PAN.

In operation, the rate markup logic 16 performs rate lookup calculations using rate lookup tables, such as Tables 1-5 described herein and stored in the database 18. While there are a large number of PAN Ranges defined by the various card associations, in reality there are a limited number of total rates that are used for DCC rate calculation.

For example, a single issuer may issues a wide variety of cards of different qualifying levels, such as Silver, Gold, and Platinum levels. The single issuer may then associate different marketing programs with each one. In general, all the different cards from that issuer will have the same rates and fees applied to them regardless of which program the cards are associated with.

In addition, while it is possible for each merchant to negotiate different rates, it is likely that all merchants for a given acquirer will all use the same rates. It is also likely that more than one acquirer will use the same rates to stay competitive in the marketplace.

In order to achieve the goal of minimizing the size of the data required for the rate calculation, the system 10 and method of the present invention takes advantage of the relational characteristic of modern databases and uses normalized data, which provides a very efficient method of determining the rate to be used for each DCC transaction.

The database 18 stores numerous records in tables, with data from the data sources 20 populating some of the tables, while other variables and parameters in other tables are changed and updated as commercial transactions are processed. FIG. 2 illustrates table relations in which a plurality of tables 32 provide data to other tables. Variable tables and static tables are used to store all of the values to be used to generate a rate for the transaction between the customer 22 and the merchant 24 in FIG. 1.

In the system 10 and method of the present invention, the plurality of tables 32 are not directly linked, but instead junction tables, also known as bridge tables, join tables, map tables, link tables, etc. are used, in which common fields from two or more tables are stored in the junction table. By using such junction tables, relationships between the tables of data in the database 18 are established which improves the speed and efficiency of data processing by the rate markup logic 16.

As shown in FIG. 2, a PANRangeLookup table 34 and a MerchantLookup table 36 provide data to a MerchantPANRateJunction table 38. A RateLookup table 40 is then populated by the MerchantPANRateJunction table 38 as well as other data such as from SaleRate, RefundRate, and Precision fields. A Currencies table 42 is populated by currency information on different types of currencies, and a RateCurrencyJunction table 44 is populated from the RateLookup table 40 and the Currencies table 42.

As shown in FIG. 2, variable tables are stored in the database 18 with sufficient information to allow the rate calculation to be performed. The variable tables would typically change on a daily basis. Examples of variable tables stored in the database 18 are the PANRangeLookup table 34, the MerchantLookup table 36, and the RateLookup table 40, with example fields of these tables 34, 36, and 40 being shown in Tables 1-3, respectively.

Referring to FIG. 2 and Table 1, the PANRangeLookup table 34 is created in order to concatenate and pre-process information related to the customer 22, such as a cardholder. The information includes cardholder specifics used in the currency conversion process.

TABLE 1

| | DATA | | |
|---|---|---|---|
| FIELD | TYPE | DEFAULT | DESCRIPTION |
| ID | int | NOT NULL | Unique value identifying this record |
| FileID | int | NOT NULL | The ID of the active set of PPTables |
| | | | data created in the PS system |
| LowPAN | varchar(20) | NOT NULL | The PAN value identifying the |
| | | | bottom of the range of valid ranges |
| | | | for this set of data |
| HighPAN | varchar(20) | NOT NULL | The PAN value identifying the top |
| | | | of the range of valid ranges for this |
| | | | set of data |
| TotalMakrupRelated | int | NOT NULL | A system ID used to identify PAN |
| | | | ranges with common attributes used |
| | | | in creating the currency conversion |
| | | | rates |
| CardType | char(2) | | Card type associated with this range |
| TotalMarkup | decimal(28, 19) | | The total markup value used to |
| | | | calculate the final conversion rate |

In creating the PANRangeLookup table 34, the processor 14 begins by taking adjacent PAN ranges, and determining if the characteristics have sufficient common values such that two rows of data can be combined into a single row. The creation of the PANRangeLookup table 34 allows many rows to be compressed into a single row.

Another step during the creation of the PANRangeLookup table 34 is identification by the processor 14 of ranges that have common attributes. After concatenation and populating of the table from multiple records, each record is evaluated by the processor 14 to determine if the record has values in common with other records using in the final calculation of the conversion or exchange rate. If a record is determined by the processor 14 to share such attributes, the identification (ID) information assigned to the record, when the record was created, is then assigned to the TotalRateMarkupID row. However, if the processor 14 determines that a record of a customer having a PAN does not exist in the PANRangeLookup table 34, the record is added and later processed with other records to possibly be matched with other records later in the process of populating the PANRangeLookup table 34. In addition, certain data associated with each PAN is stored for reference during actual transactions involving the PAN, such as a TotalMarkup value which is a fee from an international transaction fee table, which may be provided from the data sources 20, or otherwise the TotalMarkup value is a fee which is set by the commerce processing system 12.

Referring to FIG. 2 and Table 2, the MerchantLookup table 36 is a compilation of information regarding merchants configured within the commerce processing system 12. Each merchant has a corresponding record with an ID as a record key, which may be the MID or a domestic merchant ID associated with the merchant 24.

TABLE 2

| | DATA | | |
|---|---|---|---|
| FIELD | TYPE | DEFAULT | DESCRIPTION |
| ID | int | NOT NULL | Unique value identifying |
| | | | this record |
| FileID | int | NOT NULL | The ID of the active set |
| | | | of PPTables data created |
| | | | in the PS system |
| AssignedMerchantID | char(16) | NOT NULL | |
| CommonInputID | int | NOT NULL | |

During creation of the MerchantLookup table 36, all of the fields used in the calculation of rates are compared and tracked to determine different merchants with common attributes. The merchants with common attributes are assigned a common lookup ID, which allows the system 10 and method to reduce the number of merchant records used in the MerchantPANRateJunction table 38.

For calculating the rates for use with each merchant, the database 18 stores attributes and data values of the merchants which may include one or more of a merchant base currency from which the transaction amounts are to be converted, a merchant clearing currency which is a selected currency to which transaction amounts are to be converted, an acquirer processor ID, a card type, a markup method, a markup method indicator, a markup return indicator, a markup value, a base conversion precision value, and a base conversion rate value.

The processor 14 derives a base conversion rate for a transaction involving a merchant 24 by using a merchant rate source ID, a merchant base currency, and a clearing currency to determine if a record exists in the MerchantLookup table 36 corresponding to the values of the merchant rate source ID, the merchant base currency, and the clearing currency. If such a record exists for the merchant 24, then the base conversion rate in the attributes of the merchant in the record is used as the base conversion rate for the merchant and the pair of the merchant base currency and the clearing currency.

However, if no record exists for the merchant 24 involved in a transaction being processed, the processor 14 then proceeds to use an acquirer processor ID, a merchant base currency, and the clearing currency to determine if a record for the merchant 24 exists in a ProcessorBaseConversionRate table stored in the database 18. If such a record exists in the ProcessorBaseConversionRate table, then the base conversion rate of the record is used as the base conversion rate of the merchant 24 associated with the merchant base currency and clearing currency. However, if no record of the merchant 24 is found in the ProcessorBaseConversionRate table, the record is not included in the MerchantPANRateJunction table 38.

Referring to FIG. 2 and Table 3, the RateLookup table 38 holds the final calculated rates for the MerchantPANRateJunction table 38.

TABLE 3

| | DATA | | |
|---|---|---|---|
| FIELD | TYPE | DEFAULT | DESCRIPTION |
| ID | int | NOT NULL | Unique value identifying |
| | | | this record |
| FileID | int | NOT NULL | The ID of the active set |
| | | | of PPTables data created |
| | | | in the PS system |
| SaleRate | decimal(19, 10) | NOT NULL | Calculated Sale |
| | | | Conversion Rate |
| RefundRate | decimal(19, 10) | NOT NULL | Calculated Refund |
| | | | Conversion Rate |
| Precision | int | | Defined system precision |

The system 10 and method determine common records which are determined by searching for identical sale and refund rates in a table in the database 18. If a record is found, the determination uses the ID of the record. If a record is not found, the system and method creates a new record and a new ID.

The SaleRate is calculated using the following algorithm in pseudocode:

```
If the Mercant.markupMethod >= ‘M’
Then calculate using the FX Assured logic
  If the Merchant.Indicator equals ‘0’ (PAN Markup only; Markupvalue
  has no effect)
    The Result equals
    (
    Merchant.baserate * (1 + PAN.totalMarkupRate)
    )
  If the Merchant.Indicator equals ‘1’ (Increment with the markup value
and PAN Markup)
    The Result equals
    (
    Merchant.baserate * (1 + PAN.totalMarkupRate +
    Merchant.markupValue)
    )
  If the Merchant.Indicator equals ‘2’ (Decrement the markup value and
  PAN Markup)
    The Result equals
    (
    Merchant.baserate * (1 + PAN.totalMarkupRate −
    Merchant.markupValue)
    )
Else If the Mercant.markupMethod < ‘M’
Then calculate without the FX Assured logic
  If the Merchant.Indicator equals ‘0’ (Base Rate Only)
    The Result equals
    (
    Merchant.baserate
    )
  If the Merchant.Indicator equals ‘1’ (Increment with the markup value)
    The Result equals
    (
    Merchant.baserate * (1 + Merchant.markupValue)
    )
  If the Merchant.Indicator equals ‘2’ (Decrement with the markup value)
    The Result equals
    (
    Merchant.baserate * (1 − Merchant.markupValue)
    )
```

The RefundRate is calculated using the following algorithm in pseudocode:

```
    If the Merchant.creditReturnMarkupIndicator equals ‘0’
    (Base Rate Only)
        The Result equals
        (
        Merchant.baserate
        )
    If the Merchant.creditReturnMarkupIndicator equals ‘1’
                                (Increment with the markup
value)
        The Result equals
        (
        Merchant.baserate * (1 + Merchant.markupValue)
        )
    If the Merchant.creditReturnMarkupIndicator equals ‘2’
                                (Decrement with the markup
value)
        The Result equals
        (
        Merchant.baserate * (1 − Merchant.markupValue)
        )
```

As shown in FIG. 2 and Table 4, the RateCurrencyJunction table 44 is a junction table which provides a link to the currency assigned to a range of PANs associated with a final calculated rate. The currency ID information is required data used during an actual transaction.

TABLE 4

| | DATA | | |
|---|---|---|---|
| FIELD | TYPE | DEFAULT | DESCRIPTION |
| ID | int | NOT NULL | Unique value identifying |
| | | | this record |
| FileID | int | NOT NULL | The ID of the active set |
| | | | of PPTables data created |
| | | | in the PS system |
| RateLookupID | int | NOT NULL | ID of the ratelookup record |
| CurrencyID | int | NOT NULL | ID of the currency record |
| | | | identified in the process |
| | | | belonging to the PAN Range |

As shown in FIG. 2 and Table 5, the MerchantPANRateJunction table 38 is a junction table which provides a cross-reference of the PANRangeLookup table 34, the MerchantLookup table 36 and the RateLookup table 40. During processing of a new transaction involving a merchant 24 and a customer 22 using a PAN 26, if a match of previous transactions involving the same merchant 24 and customer 22 are found, then the ID in the MerchantPANRateJunction table 38 is used to identify the conversion rate in the RateLookup table 40 to be used in the new transaction. Otherwise, if no previous matching transactions are found, then a new record is created with the unique information.

TABLE 5

| | DATA | | |
|---|---|---|---|
| FIELD | TYPE | DEFAULT | DESCRIPTION |
| ID | int | NOT NULL | Unique value identifying |
| | | | this record |
| FileID | int | NOT NULL | The ID of the active set |
| | | | of PPTables data created |
| | | | in the PS system |
| MerchantLookupID | int | NOT NULL | Common Merchant ID used |
| | | | in the final calculation |
| PANrangeLookupID | int | NOT NULL | Total Markup ID used in |
| | | | the final calculation |
| RateLookupID | int | NOT NULL | Rate Record ID identifying |
| | | | the final calculated rates |

The database 18 also stores static tables which are separate from the variable tables. The static tables may include the Currencies table 42 which contains an entry for each currency supported by the system 10. The currency has no impact on the processing of a DCC calculation, but the currency is required as a separate data field to be associated with the transaction. It is not expected that the Currencies table 42 will change on a regular basis, but the Currencies table 42 may be updated to include support for new currencies or if a currency changes to support a revaluation of a currency or a conversion to another currency.

The Currencies table 42 includes a field for each record which stores at least the ISOCode associated with each currency, which is a three digit numeric code assigned by the International Organization for Standardization (ISO). Other fields include a CurrencyID field, a Currency field, a Display filed, a Symbol filed, a DecimalPlaces field, an IgnoreDigits field, a Separator field, and a RoundingUnit field, with each field used for specifying how the currency is to be processed and displayed with respect to a transaction. Optionally, an ISOAlpha filed may be used, which stores a three letter code assigned by ISO.

CurrencyID values from the Currencies table 42 are provided to the RateCurrencyJunction table 44 to be combined with the ID and FileID values from the RateLookup table 40, as well as a RateLookupID from the MerchantPANRateJunction table 38 associated with the transaction. Accordingly, using the RateCurrencyJunction table 44, the system 10 and method can readily and quickly access the currency settings and RateLookupID data associated with a transaction between the customer 22 and the merchant 24.

In operation, the system 10 and method of the present invention performs pre-processing of the data involved in a commercial transaction. Data for the RateLookup table 40 and other tables and records stored in the database 18 comes from a variety of data sources 20.

The data for the RateLookup table 40 may come from tables provided by “VISA” and “MASTERCARD” as well as other sources. The data for the MerchantLookup table 36 may come from set-up information stored in or associated with the commerce processing system 12. The data for the RateLookup table 40 is calculated using the base rates which can come from a variety of sources to include published rates from “VISA” and “MASTERCARD” as well as merchant setup information associated with each merchant 24.

Such data in the RateLookup table 40 determines what currencies are accepted and what markup to apply to the base rate to determine which rate to use for a DCC transaction associated with the merchant 24 processing a commercial transaction with the customer 22. Note that there are potentially different rates for sales and refunds, which are thus stored in different SaleRate and RefundRate fields, respectively, of RateLookup table 40.

When the “FX ASSURED” program is being executed by the processor 14, information related to the rate charged by issuers and other merchant setup information is also used to calculate the rates. As each rate is calculated, an entry is added to the MerchantPANRateTable 38 to make the association between the calculated rate and the transaction being processed involving the merchant 24 and the customer 22. The RateLookupID entry in the MerchantPANRateJunction table 44 is also associated with the matching entry in the Currencies table 42 entry using the RateCurrencyJunction table 44.

For performing a rate calculation, transaction information 28 is received by the commerce processing system 12, with the transaction information including a MID and a PAN 26. The MID is used by the processor 14 to determine which entry from the MerchantLookup table 36 applies for the transaction being processed. The PAN 26 is used by the processor 14 to determine which entry in the PANRangeLookup table 34 applies for the transaction being processed. A SQL Select command is issued by the processor 14 and sent to the database 18 to return the rows of the MerchantPANRateJunction table 38 which are valid for the merchant/PAN combination being processed. If there are none, or if more than one row is returned, the PAN 26 is not supported by the merchant 24 for DCC processing.

However, if only one row is returned, then the RateLookupID from the corresponding row in the MerchantPANRateJunction table 38 is used to select a specific row in the RateLookup table 40, in which are also stored rates and exponents used to determine the rate to be used for the current transaction being processed. The RateLookup table 40 includes additional fields having a rate, being a value which is an integer, and an exponent which determines where in the rate value the decimal point is located. For example, if the rate is 123456 and the exponent is 5, the exchange rate is 1.23456.

In order to determine the currency to be used for the current transaction being processed between the merchant 24 and the customer 22, the RateLookupID in the RateLookup table 40 is used to select all the rows in the RateCurrencyJunction table 44 that apply to the selected rate. If there are none, or if there are more than one row, there is an error and the transaction can not continue.

However, if only one row is returned, the CurrencyID in the Currencies table 42 can be used to select a row in the Currencies table 42 which provides the ISOCode and ISOAlpha values associated with this rate to be transmitted along with the mark-up rate 30 back to the merchant 24 to complete the transaction with the customer 22.

The disclosed system 10 and method of the present invention provides improved speed for determining the rate to use for a particular transaction, and improved processing and throughput of the volume of data required to store the rate lookup information, as well as taking into account the specific merchant for which the rate to be used will apply and the parameters that have been established for that merchant. In addition, the disclosed system 10 and method of the present invention, using known lowest-rate software such as “FX ASSURED”, calculate rates that are lower than the total effective rate that the cardholder would be charged for a transaction if the cardholder chose to not participate in the dynamic currency conversion process.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A system for determining currency conversion rates, the system comprising:
a database including:
a merchant-primary-account-number-rate junction table for storing records of merchants associated with primary account numbers (PANs) and currency conversation rates; and
a processor including predetermined software for processing a transaction between a first merchant and a customer associated with a first PAN, for determining a markup rate matching one of the currency conversion rates associated with the first merchant and the first PAN;
wherein the processor transmits the markup rate to the first merchant for completing the transaction using the markup rate.

2. The system of claim 1, wherein the database includes:
a rate currency junction table for storing currency indices of the currency conversion rates, with each currency index associated with a respective currency and a respective currency conversion rate in the merchant-primary-account-number-rate junction table; and
wherein the processor, using a currency index associate with the matching conversion rate, transmits an indication of the currency associate with the markup rate.
